(19) United States
(12) Patent Application Publication
(10) Pub. No.: US 2003/0200553 A1
(43) Pub. Date: Oct. 23, 2003

(54) Method and system for showing a presentation to a local and a remote audience

(76) Inventors: James R Cole, Albany, OR (US); William J. Allen, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/125,960

(22) Filed: Apr. 18, 2002

(51) Int. Cl. H04N 7/16

(52) U.S. Cl. 725/141

(57) ABSTRACT

A method and system for showing a presentation to a local and a remote audience is disclosed. The system includes a display device for presenting an information frame to the local audience. Coupled to the display device is a frame capture device for capturing an image of the information frame presented to the local audience. A transmission device, coupled to the display device, transmits the image of the information frame to a remote audience member.

### BACKGROUND OF THE INVENTION

The invention pertains generally to equipment used to show presentations to audiences and, more particularly, to methods and systems for showing presentations to audiences located in different areas.

When a presenter shows a presentation to an audience located in the same room as the presenter, the presenter typically has control over the material presented to the audience. For example, if the presentation consists of a set of transparent slides presented by way of an overhead projector, the presenter can select precisely which transparent slides are shown to the local audience. In another example, in which the presenter shows “information frames” to a local audience by way of an electronic projector in lieu of transparent slides shown by way of an overhead projector, the presenter generally has control over the computing device that controls which information frames are shown to the audience. In both examples, the presenter may skip over certain material in the presentation, as well as include “backup” material in order to tailor the presentation to the particular local audience.

When a presenter wishes to show a presentation to a remote audience (i.e. and audience not located in the same room as the presenter), the presenter may choose to make use of a network meeting computer program that enables presentation material to be transmitted from the presenter's computing device to the members of the remote audience. However, the use of such network meeting computer programs generally requires that the presenter be interfaced to a network that is accessible to the members of the remote audience. Thus, an outside visitor giving a presentation to an enterprise that includes a remote audience may first be required to obtain approvals from the enterprise's information technology personnel prior to interfacing the outside visitor's computing device to the enterprise network. Additionally, the visitor's computing device may need to be configured before any communication on the enterprise network can take place. The need to obtain approvals as well as the need to configure the computing device prior to interfacing the device to the enterprise network can be a time consuming process that places an additional burden on both the enterprise as well as on the outside visitor.

One proposed solution might be for the visitor to electronically mail the presentation to the members of the remote audience prior to beginning the presentation. However, this typically requires a connection to an electronic mail server, which, in turn, requires that the visitor interface the computing device to the enterprise network. Another approach might be for the visitor to provide a computer disk containing the presentation file to a representative within the enterprise so that the presentation can be electronically mailed from a computer already interfaced to the enterprise network. However, this can also be cumbersome in that the outside visitor may be required to remove the portions of the presentation which are proprietary to the outside visitor's organization or otherwise not intended for general dissemination with the enterprise.

### BRIEF DESCRIPTION OF THE DRAWINGS

FIG. 1 is a block diagram of a system for showing a presentation to a local and a remote audience in accordance with a first embodiment of the invention;

FIG. 2 is a block diagram of a second system for showing a presentation to a remote audience in accordance with a second embodiment of the invention;

FIG. 2A is a block diagram of an alternative implementation of portions of the embodiment of FIG. 2;

FIG. 3 is a flowchart of a first method for showing a presentation to a local and a remote audience in accordance with an embodiment of the invention; and

FIG. 4 is a flowchart of a second method for showing a presentation to a local and a remote audience in accordance with another embodiment of the invention.

### DETAILED DESCRIPTION OF THE EMBODIMENTS

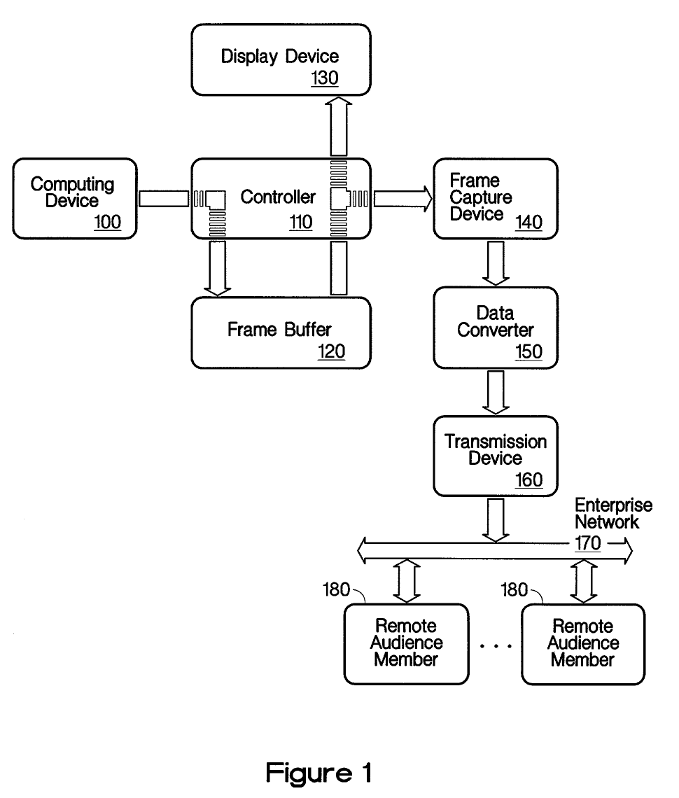

FIG. 1 is a block diagram of a system for showing a presentation to a local and a remote audience in accordance with a first embodiment of the invention. In FIG. 1, computing device 100 represents an information source that conveys information frames to controller 110. In the context of the present invention, an information frame represents a discrete portion of a presentation, comparable to a transparent slide shown by way of an overhead projector. The information frame may be generated by way of any one of several graphics presentation computer programs such as Microsoft PowerPoint®.

Computing device 100 can be a portable laptop computer, handheld computing device, or any other computing device that performs general-purpose or special-purpose processing functions, and may be used to develop and/or display information frames by way of a computer program such as Microsoft PowerPoint®, as previously mentioned. In the embodiment of FIG. 1, computing device 100 communicates with controller 110 by way of a video interface in which information frames are conveyed from the computing device in the form of fluctuating voltages generated by appropriate outputs of computing device 100. Alternatively, computing device 100 communicates with controller 110 by way of a digital interface.

Outputs from computing device 100 are conveyed through controller 110 to frame buffer 120. In FIG. 1, frame buffer 120 represents a video random access memory (VRAM) device under the control of controller 110, but may be implemented using any number of available memory devices and technologies. In the embodiment of FIG. 1, information frames from computing device 100 are stored in a memory array within frame buffer 120 and conveyed to display device 130, again under the control of controller 110. Desirably, a memory controller unit (not shown in FIG. 1) operates within controller 110 to coordinate the memory storage and retrieval functions within frame buffer 120.

In FIG. 1, controller 110 digitizes the video signals received from computing device 100. Additionally, controller 110 also performs scaling functions such as modifying the screen resolution of computing device 110 to accord with the screen resolution of display device 130. For example, in the event that computing device 100 provides a Super Video Graphics Array (SVGA) compatible output of 800 lines horizontal by 600 lines vertical, controller 100 may scale the output of computing device 100 to accord with a different screen resolution, such as 1024 lines horizontal by 768 lines vertical, as may be required by display device 130. Controller 110 may also perform timing functions in which the signal update rate of the outputs of computing device 100 is synchronized to accord with the update rate of display device 130.

Display device 130 can include a light source and optics that focus the light on an image engine. The image engine may make use of transmissive panels, polysilicon liquid crystal display, or other technology that modulates one or more beams of light with information stored in the memory array of frame buffer 120. The resulting information frame produced by the image engine is focused for display on an external surface preferably large enough to be viewed by the local audience. In another embodiment, display device 130 is a cathode ray tube, liquid crystal display, organic light emitting diode, or other monitor technology.

In addition to being coupled to display device 130, controller 110 is also coupled to frame capture device 140. Frame capture device 140 reads the picture elements (i.e. pixels) from the memory array within frame buffer 120. These picture elements are transmitted to data converter 150 where the data converter converts the picture elements to a more standardized serial or parallel format. Controller 110 or computer 100 may include a blanking input that permits the presenter to control whether a particular information frame is presented. This allows the user of computing device 100 to control which information frames are presented to the local audience (by way of display device 130) and which images of the information frames are presented to remote audience members 180 (as described hereinafter).

As previously mentioned, the image of the information frame is converted to a graphics object by data converter 150. Data converter 150 formats the raw data from frame capture device 140 into a substantially standardized format, such as a Joint Photographic Experts Group (JPEG), a graphical interchange format (GIF), or a bitmapped file. The graphics object is then transmitted on enterprise network 170 by way of transmission device 160. Enterprise network 170 may represent a wireless network, a wireline network, or may include elements of both.

Transmission device 160 preferably performs an Internet Web server function in which graphics objects are transmitted (or served) along a communication network. Thus, transmission device 160 is assigned an Internet protocol (IP) address that is provided to remote audience members 180, preferably prior to the beginning of the presentation. This allows members of the remote audience to the view images of the information frames as the corresponding information frames are presented to the local audience. In the event that enterprise network 170 includes an interface to the public Internet, remote audience members 180 can be located anywhere that can access the public Internet by way of a computing device operated by the remote audience member.

The audio portion of the presentation can be delivered to the remote audience in a number of ways. In one embodiment, a telephone conference bridge facilitates the audio portion of the presentation. In another embodiment, transmission device 160 includes a Voice Over Internet Protocol (VOIP) capability that allows audio to be transmitted over enterprise network 170.

In the embodiment of FIG. 1, one or more of remote audience members 180 contacts transmission device 160 by way of enterprise network 170. This can be performed by way of remote audience members 180 inputting the IP address of transmission device 160 into a computing device associated with each of the members. Upon establishing a connection with each of remote audience members 180, transmission device 160 may perform authentication and verification in accordance with any applicable information technology security guidelines required within the enterprise. Transmission device 160 then serves the graphics objects that correspond to the images of each information frame to each of remote audience members 180. Preferably, the graphics objects are capable of being viewed by way of the remote audience members 180 using a computing device that runs an Internet browser, a word processing program, or a graphics presentation program.

Preferably, frame capture device 140 captures images of each information frame soon after the corresponding image is presented to the local audience by display device 130. This image is then converted to a graphics object and conveyed to transmission device 160. The graphics object can then be served to remote audience members 180 in response to a query from each of the members, such as the member selecting to “refresh” the browser window. In another embodiment, transmission device 160 makes use of “push” technology in which the graphics object is transmitted to remote audience members 180 without requiring a “refresh” input from the members. In another embodiment, transmission device 160 makes use of a file transfer protocol to make each graphics object available to remote audience members 180.

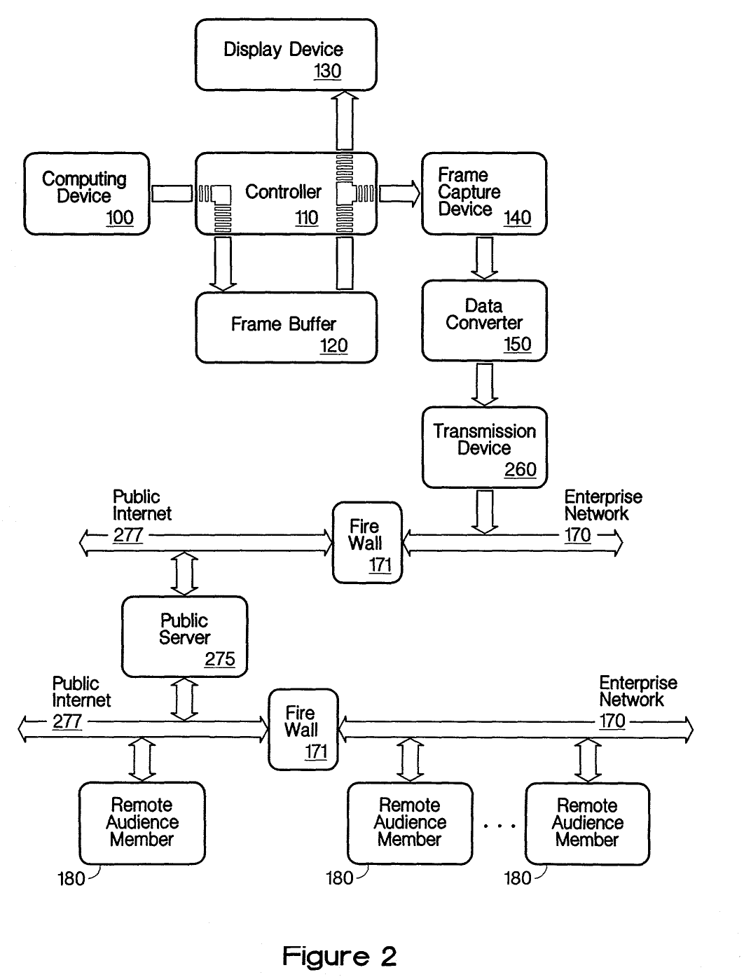

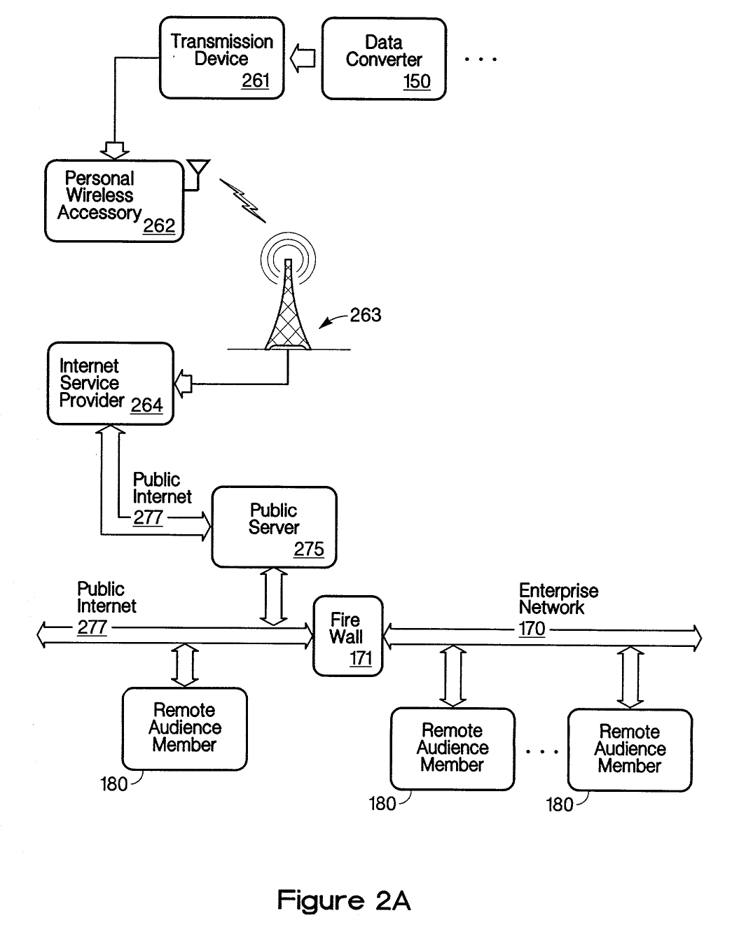

FIG. 2 is a block diagram of a second system for showing a presentation to a local and a remote audience in accordance with a second embodiment of the invention. In FIG. 2, computing device 100, frame buffer 120, controller 110, display device 130, frame capture device 140, data converter 150, and enterprise network 170 operate in a manner substantially similar to that described with reference to FIG. 1. In FIG. 2, firewall 171 represents a network element that controls access between enterprise network 170 and public Internet 277.

In FIG. 2, transmission device 260 receives graphics objects from data converter 150, in a manner similar to the operation of transmission device 160 of FIG. 1. However, in contrast to transmission device 160, transmission device 260 does not serve graphics objects directly to remote audience members 180. Rather, transmission device 260 transmits the graphics objects received from data converter 150 to public server 275 by way of enterprise network 170 and public Internet 277. Public server 275, in turn, serves the received graphics object to remote audience members 180 by way of public Internet 277, as accessed by remote audience members 180 through firewall 171. Although only a single one of remote audience members 180 is shown as being interfaced to public Internet 277, a greater number of remote audience members 180 can be interfaced to the public Internet.

Public server 275 of FIG. 2 is contemplated as having a network address on Public Internet 277. In an alternate embodiment, public Internet 277 can be replaced by another type of wireless or wireline data communications network, such as an Ethernet (wireline) or IEEE 802.11 (wireless) network. Public server 275 may be a conventional medium or high-capacity server whose functions include performing public Internet server related tasks. Public server 275 may be operated by a service provider that serves general-purpose web pages to clients interfaced to public Internet 277.

As previously mentioned, public server 275 is contemplated as being more closely related to a public Internet general-purpose network server than transmission device 160 of FIG. 1. Thus, public server 275 may perform security and encryption functions over and above those performed by transmission device 260. These additional functions can include security and password layers that limit access to the server, data encryption/decryption, as well as user authentication and verification techniques. Further, as public server 275 is viewed as being more of a network resource than a physical resource, the functions performed by public server 275 may be migrated to other network resources located at other locations served by public Internet 277.

FIG. 2A is a block diagram of an alternative implementation of portions of the embodiment of FIG. 2. In the embodiment of FIG. 2A, transmission device 261 interfaces with data converter 150 in a manner similar to the interface of transmission device 260 with data converter 150 of FIG. 2. For purposes of simplicity, frame capture device 140, frame buffer 120, display device 130, controller 110, and computing device 100 are not shown in FIG. 2A.

Transmission device 261 interfaces with personal wireless accessory 262. Personal wireless accessory 262 represents any personal wireless communications device such as a cellular telephone, personal digital assistant (PDA) having a wireless communications capability, portable computing device that includes a wireless local area network capability, or can be any other type of personal wireless device. In this embodiment, transmission device 261 uploads the graphics objects corresponding to images of the information frames to an Internet service provider 264 by way of personal wireless accessory 262. This uploading can be accomplished by way of a wireless transmission through cellular communications tower 263.

The graphics objects from transmission device 261 can be conveyed to Internet service provider 264 by way of a data transport protocol such as general packet radio service (GPRS), which allows the personal wireless accessory 262 to wirelessly transmit and receive generic data to and from public Internet 277 using an intervening cellular communications infrastructure. In an alternate embodiment, cellular communications tower 263 can be replaced by a wireless access point located within the enterprise. In either embodiment, the graphics objects are then conveyed to public server 275 for distribution to remote audience members 180 (through firewall 171 which separates public Internet 277 from enterprise network 170). As in FIG. 2, although only a single one of remote audience members 180 is shown as being interfaced to public Internet 277 (in FIG. 2A), a greater number of remote audience members 180 can be interfaced to the public Internet.

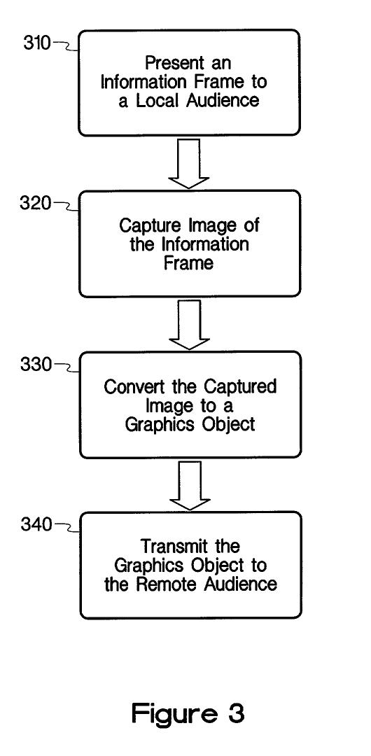

FIG. 3 is a flowchart of a first method for showing a presentation to a local and a remote audience in accordance with an embodiment of the invention. The system of FIGS. 1, 2, 2A, and 3 are suitable for performing the method of FIG. 3. FIG. 3 begins at step 310 in which an information frame is presented to a local audience using a display device. Desirably, the information frame is projected onto a single viewing surface that can be seen by the local audience. Alternatively, the information frame is projected onto a computer or other monitor having a viewing surface that can be viewed by the local audience. The method continues at step 320 in which an image of the information frame is captured by a frame capture device. Step 320 may include the frame capture device reading a memory array that stores the information frame in a random access memory.

At step 330, the captured image is converted to a graphics object. Preferably, the conversion of step 330 includes conversion of the raw data captured in step 320 into a standardized format such as a bitmapped file, a JPEG file, or a GIF file, which can be transported along a wireless or wireline communications network such as an enterprise network, or along the public Internet. The graphics object can then be viewed by way of an Internet browser, word processing program, or other computer program. Alternatively, the graphics object can be formatted in a manner that allows the graphics object to be viewed using a file transfer protocol.

At step 340, the graphics object is transmitted to the remote audience by way of a server that communicates with members of the remote audience using an Internet or other protocol. Step 340 may include the transmission of graphics objects to a server located on a public network located outside of the enterprise. The transmission of the graphics objects to the server located on the public network can also be accomplished by way of a wireless communications device, such as a cellular telephone that transmits the graphics objects to the server using an intervening cellular communications infrastructure. Further, the transmission of step 340 can be the result of a remote audience member selecting to “refresh” a browser window that displays a previous graphics object, thereby requesting the current graphics object.

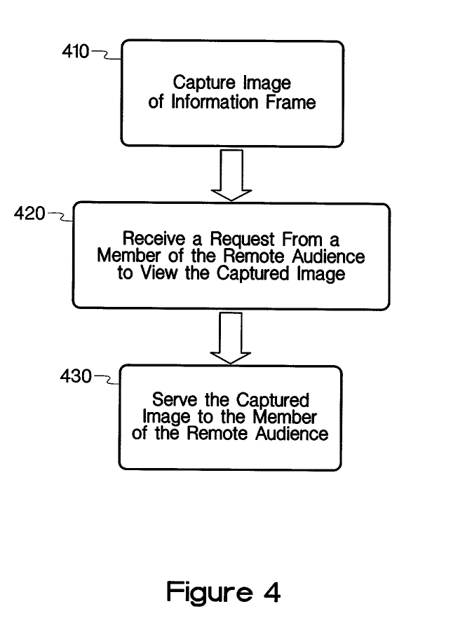

FIG. 4 is a flowchart of a second method for showing a presentation to a local and a remote audience in accordance with and embodiment of the invention. The system of FIGS. 1, 2, 2A, and 3 are suitable for performing the method of FIG. 4 in which the captured image of the method corresponds to the graphics object of FIGS. 1, 2, 2A, and 3. However, the method of FIG. 4 may be practiced by other equipment capable of showing presentations to both local and remote audiences that does not serve graphics objects the audiences. This other equipment may transmit the captured images using, for example, a file transfer protocol.

FIG. 4 begins at step 410, in which an image of an information frame is captured by a frame capture device. Preferably, the captured image of the information frame is substantially identical to an information frame shown on a viewing surface that can be viewed by members of a local audience. In step 420, a request to view the captured image is received from a member of the remote audience. The request of step 420 can represent a remote audience member logging into a server that serves the captured images in a manner that accords with the embodiments of the invention described herein. The request of step 420 can also include the remote audience member requesting a captured image by selecting to “refresh” a browser window that displays a previous graphics object, thereby requesting the current graphics object. At step 430, the captured image is served to the member of the remote audience. Step 430 can be accomplished by way of a server that transmits to the member of the remote audience using an enterprise network or by way of the public Internet.

In conclusion, while the present invention has been particularly shown and described with reference to the foregoing preferred and alternative embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A system for showing a presentation to a local and a remote audience, comprising:
a display device for presenting an information frame to the local audience;
a frame capture device, coupled to the display device, for capturing an image of the information frame presented to the local audience; and
a transmission device, coupled to the frame capture device, which transmits the image of the information frame to a remote audience member.

2. The system of claim 1, further comprising a data converter, coupled to the frame capture device and to the transmission device, for converting the image of the information frame to a graphics object.

3. The system of claim 1, wherein the display device is a projector that projects at least one beam of light toward an external surface.

4. The system of claim 1, wherein the display device is a monitor that includes a viewing surface.

5. The system of claim 1, wherein the display device receives the information frame by way of a video interface.

6. The system of claim 1, wherein the transmission device is interfaced to a communications network.

7. The system of claim 6, wherein the communications network is the public Internet.

8. A method of showing a presentation to a local and a remote audience comprising:
presenting an information frame to the local audience;
capturing an image of the information frame;
converting the captured image to a graphics object; and
transmitting the graphics object to at least one member of the remote audience.

9. The method of claim 8, wherein the presenting step includes projecting the information frame onto a viewing surface that is seen by the local audience.

10. The method of claim 8, wherein the capturing step includes reading a memory array that stores the information frame in a random access memory.

11. The method of claim 8, wherein the transmitting step is performed by a server located at a network address.

12. The method of claim 11, wherein the transmitting step is performed by way of a personal wireless accessory that transmits the graphics object to an Internet service provider.

13. The method of claim 12, wherein the wireless communications device is one of a cellular telephone, a personal digital assistant, and a portable computing device that includes a wireless local area network capability.

14. The method of claim 11, further comprising transmitting the captured image to the server by way of the public Internet.

15. The method of claim 8, wherein the graphics object is capable of being viewed by the at least one member of the remote audience using a computing device.

16. The method of claim 15, wherein the graphics object is capable of being viewed by way of the computing device using a computer program selected from the group consisting of: an Internet browser, a word processing program, and a graphics presentation program.

17. The method of claim 15, wherein the graphics object is transmitted to the at least one member using a file transfer protocol.

18. The method of claim 8, wherein the graphics object is one of a bitmap formatted file, a Joint Photographic Experts Group formatted file, and a graphics interchange formatted file.

19. In a system for viewing a presentation by both a local and a remote audience, a method comprising:
capturing an image of an information frame, the information frame being presented on an external surface;
receiving, from at least one member of the remote audience, a request to view the captured image of the information frame; and
serving the captured image to the at least one member in response to the request.

20. The method of claim 19, wherein at least one of the system and the at least one member are assigned an Internet Protocol address.

21. The method of claim 19, additionally comprising the at least one member viewing the captured image by way of a web browser.

22. The method of claim 21, wherein the captured image is one of a bitmap-formatted file, a Joint Photographic Experts Group formatted file, and a graphics interchange formatted file.

23. A system for presenting to a local and a remote audience, comprising:
means for displaying an information frame on an external surface;
means for capturing an image of the information frame, the means for capturing being coupled to the means for displaying;
means for converting the captured image to a graphics object, the means for converting being coupled to the means for capturing; and
means for conveying the graphics object to the remote audience, the means for conveying being coupled to the means for converting.

24. The system of claim 23, wherein the means for displaying is a projector that projects at least one beam of light toward the external surface.

25. The system of claim 23, wherein the means for conveying the graphics object is an interface to a communications network.

26. The system of claim 25, wherein the communications network is the public Internet.
